(19) United States
(12) Patent Application Publication
(10) Pub. No.: US 2026/0054298 A1
(43) Pub. Date: Feb. 26, 2026

(54) Method of Clearing an Intake of a Jet-Powered Water Vehicle with a Tool

(71) Applicant: Jonathan Castro, North Bay Village, FL (US)

(72) Inventor: Jonathan Castro, North Bay Village, FL (US)

(21) Appl. No.: 18/810,517

(22) Filed: Aug. 21, 2024

(51) Int. Cl. B08B 9/027

(52) U.S. Cl. CPC B08B 9/027; B08B 2209/027

(57) ABSTRACT

A method clears a blockage from an intake grate of a jet-powered water vehicle. The method involves providing a tool. The next step is inserting the tool into the cleanout port of the jet-powered water vehicle. The next step is moving said distal tip along said intake grate to clear the blockage from the intake grate. The tool for cleaning a blockage from the intake of the jet-powered water vehicle includes a shaft and a handle. The shaft has a distal end, a proximal end, and a length between said distal end and said proximal end. The length is at least as long enough to reach the intake from a top of the access port. The handle is connected to the proximal end. The handle is wider than the access port.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to methods for cleaning out intake obstructions in jet-propelled water vessels.

### Description of the Related Art

Jet boats such as those sold under the trademark YAMAHA have clean out ports for clearing blockages in intakes of their jet propulsion systems. On the stern of such boats, a hatch is provided on the swim platform. In this hatch, a cleanout port for each engine is formed: one cleanout port for a single engine jet boat and two cleanout ports for a twin-engine jet boat. The clean out ports are thirteen centimeters (13 cm) in diameter. Each port is covered by a clean out plug which has to be removed before cleaning out the debris. Depending on the year of the boat, the cleanout plug can be twisting lock clean out plug or a push button clean out plug. Once one removes the clean out plug, the drive shaft is visible in the middle of the clean out port. To clean out the seaweed or debris stuck in the propulsion system, one must stick one's hand in through either side of the drive shaft, reach down as far as one can, and grab the seaweed or debris so that one can pull the seaweed or debris from the clean out port.

In jet boats without a clean out port, a captain must attempt a reverse and forward type of maneuver. Then, while shutting off the engine, a person must enter the water, submerge beneath the transom of the boat, reach to and perhaps into the intake grate, and attempt to remove whatever is obstructing the intake grate or fouling the other intake parts.

Despite the advantages that a clean-out port offer, the solution has shortcomings. Some shortcomings of the clean-out port follow.

First, the drive shaft is right in the middle of the intake and the drive shaft is two and five tenths centimeters (2.5 cm) in diameter. So, one has to insert one's arm into the clean out, slide past the drive shaft, and reach to the seaweed in the intake grate. The passage on either side of the drive shaft is five centimeters (5 cm). Due to the size of their forearm, many people will be limited to how deep into the intake he or she can reach past the drive shaft based on the width of the person's forearm. Typical sized males will have difficulty reaching past the drive shaft to the intake grate. In addition, the distance from the drive shaft to the intake grate is at an angle of about one hundred thirty-five degrees (135°) from the clean out ports. So, one must bend one's arm at the elbow to reach the seaweed. The intake grate is twenty centimeters (20 cm) from the drive shaft and sixty-one centimeters (61 cm) from the top of the clean out port. In order to fully reach the seaweed without any problems, one's arm must be longer than sixty-one centimeters (61 cm) from one's fingertip to the base of one's shoulders. Often a user with larger forearms or shorter arms, will need to find a user with narrower forearms or longer arms to clear the blockage. The length of the reach, the angle, and drive shaft mean that for many men, they are able to touch the seaweed but are not able to reach far enough to grasp the obstruction.

Second, throughout the prior-art cleanout process, the person reaching into the cleanout is bent over on her or his knees, trying to reach the seaweed or debris. This is not a problem in calm water but stability becomes a huge problem in rough seas, especially when the boat is not powered. One literally hangs from the swim platform of the boat with one's feet in the water as the waves are moving the boat up and down while one is reaching into the clean-out for the obstruction.

Third, because of the angle of the cleanout port, one cannot see the entire intake from the cleanout port. One may think that one has removed all of the seaweed but, in fact, the blockage remains. So, a mistaken user can close the hatch, restart the engines, and prepare to depart, just to find out that when one applies, the throttle, one realizes that the intake is in-fact still obstructed. Obstructions can be detected by engine noise and higher than expected engine rpm's. If the engine remains obstructed, one must, again, cut the water vehicle's engines, and repeat the clean-out process.

### BRIEF SUMMARY OF THE INVENTION

An object of the invention is to provide a method of clearing an intake of a jet-powered water vehicle with a tool that overcomes the disadvantages of the devices and methods of this general type and of the prior art. In accordance with the object of the invention, a method for clearing a blockage from an intake grate of a jet-powered water vehicle is provided. The method is particularly applicable to jet-powered water vehicles that have a cleanout port for accessing the intake grate of the jet engine. A first step of the method is providing a tool with a shaft having a length. The length is at least as long enough to reach a distal point of the intake grate less a length of a forearm of a user. The shaft has a distal tip on the shaft. The next step is inserting the shaft into the cleanout port. The next step is moving the distal tip along the intake grate to clear the blockage from the intake grate.

In accordance with the objects of the invention, the distal tip of the shaft is narrower than a space between adjacent tines of the intake grate.

In accordance with the objects of the invention, the shaft of the tool is narrower than the distal tip of the tool.

In accordance with the objects of the invention, the shaft is made of flexible resilient material.

In accordance with the objects of the invention, the flexible resilient material is a resin.

In accordance with the objects of the invention, the flexible resilient material includes crosslinked polyethylene.

In accordance with the objects of the invention, the shaft is a tube. By being a tube with closed ends, the walls of the tube define a pocket of air therewithin. The pocket of air allows the tool to float in water. The size of the pocket of air should be large enough compared to the weight of the tool to make the tool net buoyant.

In accordance with the objects of the invention, the tool has a handle connected to a proximal end of the shaft. The handle is wider than the cleanout port. The length of the shaft is at least as long as a distance from a top of the cleanout port to the distal point of the intake grate. By being wider than the cleanout port, the handle prevents the tool from being dropped through the port. A handle that is at least twenty-two centimeters wide is wider than the most common cleanout port.

In accordance with the objects of the invention, the method includes the step of removing an access port cap from the cleanout port before inserting the shaft into the cleanout port.

In accordance with the objects of the invention, the jet-powered water vehicle has a hull, and the cleanout port provides access from above the hull to the engine's inlet.

In accordance with the objects of the invention, the method of cleaning the intake includes standing on a swim platform of the jet-powered water vehicle while inserting the shaft into the cleanout port.

In accordance with the objects of the invention, a tool with a shaft having a length at least one hundred nine centimeters is provided. A tool with a shaft of that length is able to reach an entirety of the engine intake without inserting the handle into the cleanout port.

In accordance with the objects of the invention, a method is provided for clearing a blockage from an intake on a jet-powered water vehicle having an access port for accessing the intake from a swim platform of the jet-powered water vehicle. The first step of the method includes providing a tool with a shaft having a length and a distal tip. The length is at least as long enough to reach at least one of an intake grate, a drive shaft, an impeller, a pump housing, and a jet thrust nozzle. The next step is inserting the shaft into the access port. The next step is moving the distal tip along one or more intake grates, a drive shaft, an impeller, a pump housing, and a jet thrust nozzle to clear the blockage from the intake.

In accordance with the objects of the invention, a tool is provided for cleaning a blockage from an intake of a jet-powered water vehicle having an access port for accessing the intake. The tool includes a shaft and a handle. The shaft has a distal end, a proximal end, and a length between the distal end and the proximal end. The length is at least as long enough to reach the intake from a top of the access port. The handle is connected to the proximal end. The handle is wider than the access port.

In accordance with the objects of the invention, the shaft includes a reinforced polyethylene tube.

In accordance with the objects of the invention, the shaft and the handle are formed as a unibody. The unibody tool can be made by injection molding the tool.

These and other features, aspects, and advantages of the present invention will become better understood with reference to the following description and appended claims.

### BRIEF DESCRIPTION OF THE SEVERAL VIEWS OF THE DRAWING

FIG. 1 is bottom, front, left perspective view of a tool according to the invention.

FIG. 2 shows a partial view of two of the tools shown in FIG. 1 inserted into respective access ports of a jet-powered water vehicle, in which the access ports have had their access port caps detached from their access ports.

FIG. 3 is a bottom, front, right perspective view of the jet-powered water vehicle shown in FIG. 2 with the tools extending beyond respective intake grates.

FIG. 4 is a right sectional view of a propulsion system of the jet-powered water vehicle shown in FIG. 3.

FIG. 5 is a top perspective view of one of the access ports shown in FIG. 2.

FIG. 6 is a front side view of a unibody tool according to the invention.

### DETAILED DESCRIPTION OF THE INVENTION

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

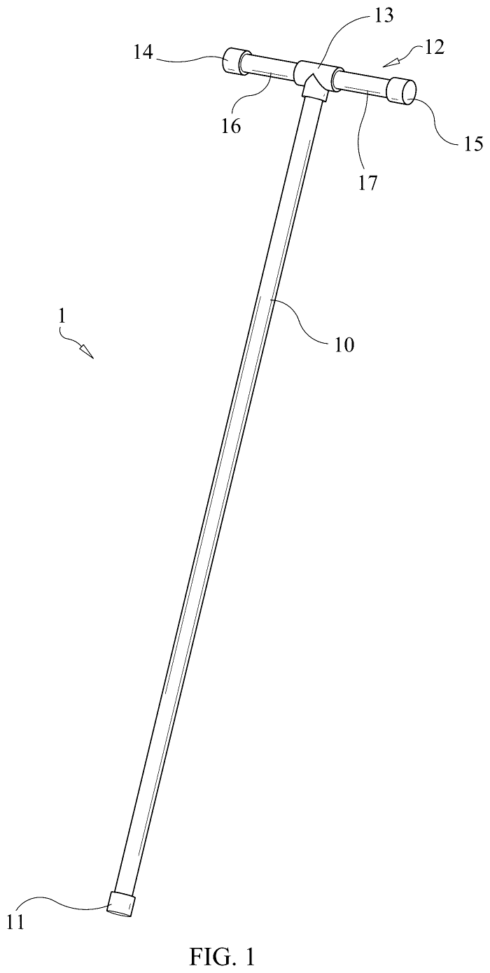

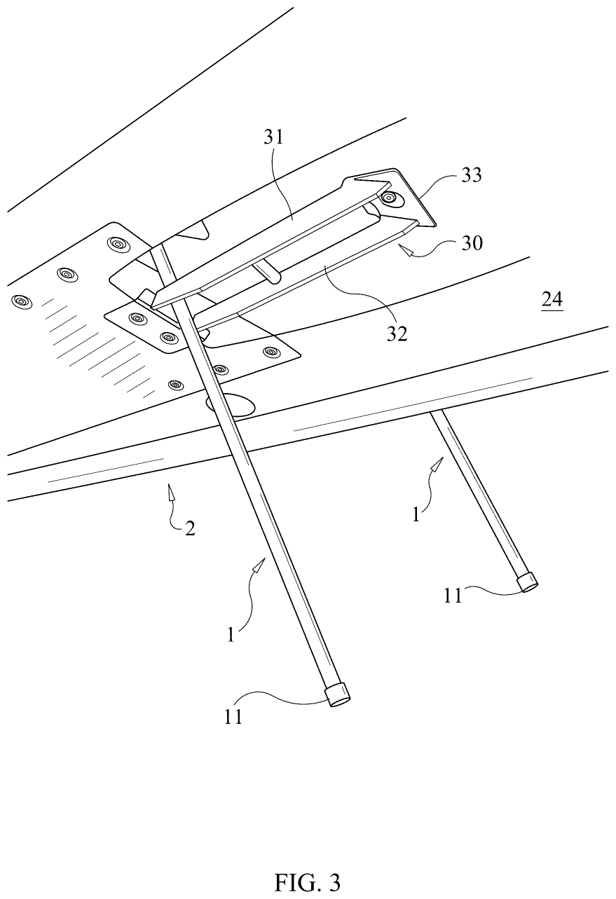

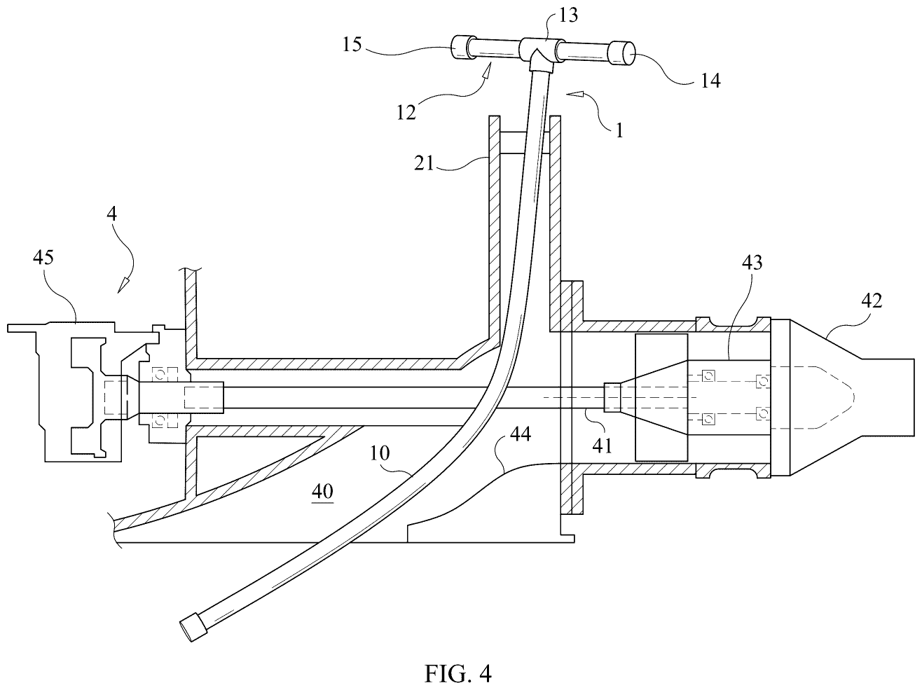

FIGS. 1-5 illustrate a method for clearing a blockage (e.g. flotsam such as seaweed) from an intake 40 of a jet-powered water vehicle by using a tool 1. The tool 1 includes a tool shaft 10. The tool shaft 10 has a distal tip 11 and a proximal handle 12. The proximal handle 12 extends bilaterally from the tool shaft 10. The proximal handle 12 is wider than a width of an access port 21. In a preferred embodiment, a width of the proximal handle is at least twenty-two centimeters (>22 cm) wide. A preferred length of the tool shaft 10 from the distal tip to the proximal handle 12 is long enough to at least reach a distal point of an intake grate 30 (as shown in FIGS. 3-4) when the tool 1 is fully inserted (i.e., with the proximal handle 12 abutting a top of the access port 21) in the access port 21. A preferred length of the tool shaft 10 is at least one hundred nine centimeters (>109 cm). The tool shaft 10 is made from a flexible material. The tool shaft 10 is flexible enough to bend enough when inserted into the access port 21 so that the distal tip 11 can reach an intake grate 30 without permanently bending or breaking. The tool 1 has a closed cavity (which is not shown) within the tool shaft 10. The closed cavity makes the tool 1 buoyant.

FIG. 1 shows a first preferred embodiment of the tool 1. The tool shaft 10 is a tube. The distal tip 11 is a cap cemented on one end of the tool shaft 10. The proximal handle 12 is formed by a T-pipe connector 13. A right tube 16 is inserted in the T-pipe connector 13. A right cap 14 closes an end of the right tube 16. A left tube 17 is inserted in the T-pipe connector 13. The left cap 15 closes an end of the left tube 17.

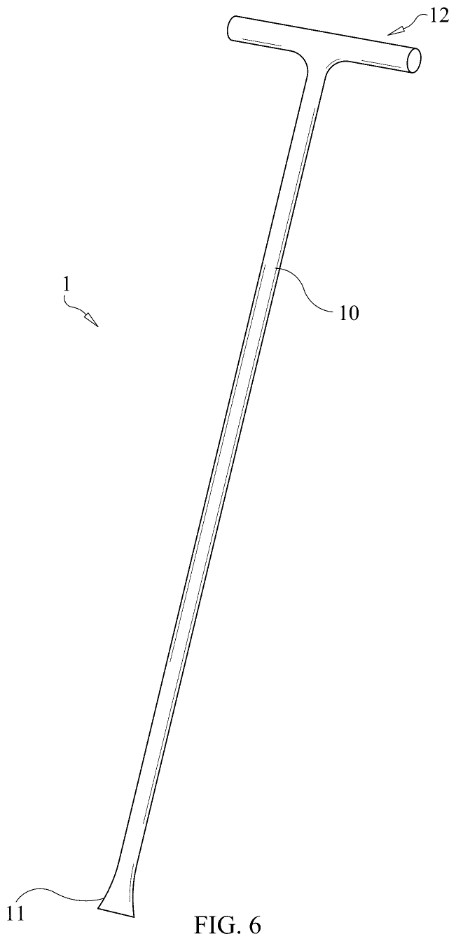

FIG. 6 shows a unibody embodiment of the tool: i.e., a unibody tool 1. The unibody tool 1 is formed as one piece preferably by injection molding. The tool includes a tool shaft 10. The tool shaft 10 has a distal tip 11 and a proximal handle 12. The distal tip 11 is wider than the tool shaft 10. The proximal handle 12 is wider than an access port 21, which is described in greater detail below. The unibody tool 1 has an airtight hollow within it which is large enough to make the unibody tool 1 buoyant. The unibody tool 1 is made of injection molded reinforced polyethylene.

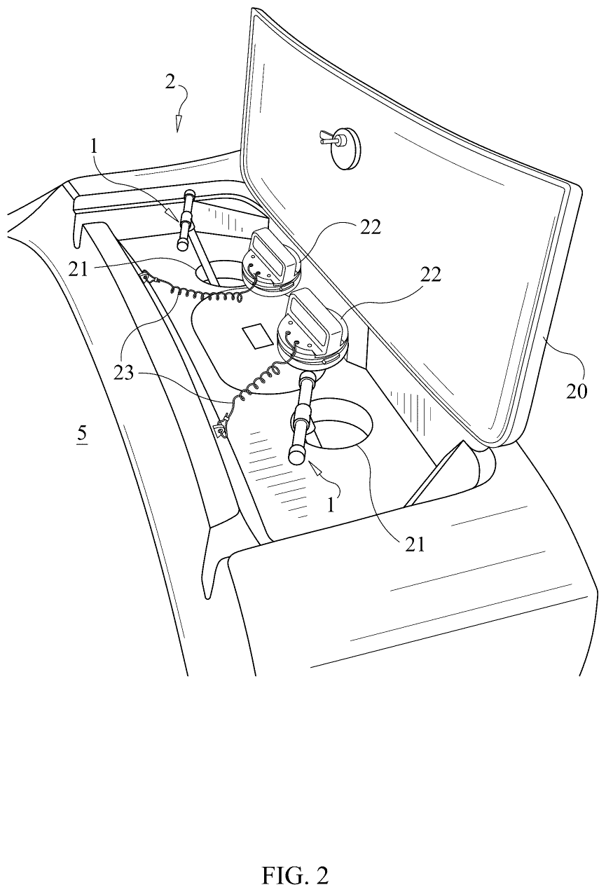

FIG. 2 shows a rear of a jet-powered water vehicle 2. A hatch 20 is disposed between a swim platform (not shown) and a passenger cabin (not shown) of the jet-powered water vehicle 2. The hatch 20 can be opened to expose two access ports 21. Each access port 21 has a removable access port cap 22. Each access port cap 22 is attached with a respective leash 23 to the jet-powered water vehicle 2. A tool 1 is shown inserted in each access port 21.

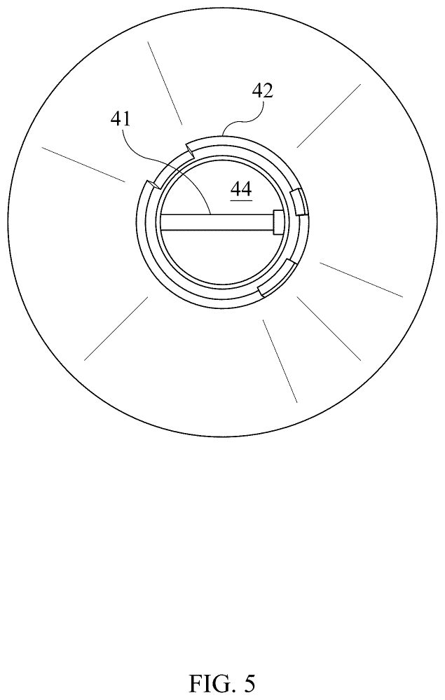

FIG. 3 shows a hull 24 of the jet-powered water vehicle 2 with an intake grate 30 protecting an intake 40 (as shown in FIG. 4) from accidentally intaking flotsam (e.g. seaweed). The intake grate 30 allows water to reach an impeller 43 (as shown in FIG. 4). The intake grate 30 includes a right tine 31 and left tine 32. When the tool 1 is inserted as shown in FIG. 2, the distal tip 11 of the tool 1 reaches through the intake grate 30. If seaweed (not shown) fouls the intake grate 30, the tool 1 can be used to free the seaweed from the right tine 31 and left tine 32, or other points of the propulsion unit 4. The user can reach all parts of the intake grate 30 with the tool 1 and does not need to reach her or his hand into the access port 21. Reaching with the tool 1 only (and, therefore, not reaching by hand into the access port 21) allows the user to stand in a more balanced position that tends to prevent the user from being bumped from the swim platform 5 during cleanout. By reaching into the access port 21 with the tool 1 and not one's hand, the user can see at least part of the intake 40 and the impeller shaft 41 as shown in FIG. 5.

FIG. 4 shows a tool 1 inserted into an access port 21 of a propulsion unit 4 of the jet-powered water vehicle 2. The propulsion unit 4 defines a passage identified as the intake 40. The access port 21 is a vertical tube that descends to the intake 40. A motor 45, turns an impeller shaft 41, which rotates an impeller 43, which forces water through a nozzle 42. The impeller shaft 41 typically runs directly below the access port 21. The tool 1 is shown reaching down the access port 21, along the impeller shaft 41 through the intake 40 to beyond the intake grate 30, which is not shown in FIG. 4. The tool shaft 10 is flexible enough to bend as it is deflected by an aft wall 44 of the intake 40.

FIG. 5 shows what a boater sees when looking down the access port 21 when the access port cap 22 has been removed. The impeller shaft 41 can be seen through the access port 21. The aft wall 44 of the intake 40 is visible beneath the impeller shaft 41. The intake grate 30 is not visible using the access port 21.

To use the tool 1, a user stands on a swim platform 5 at an aft of the jet-powered water vehicle 2. As shown in FIG. 2, the user opens the hatch 20. In the next step, the user removes the access port cap 22 from its respective access port. With the access port cap 22 removed, the user can insert the tool 1 into the access port 21. As shown in FIG. 3, when the tool 1 has been fully inserted in the access port 21, the distal tip 11 extends through the intake grate 30 and can be used to push any obstruction caught on the tines 31 and 32 of the intake grate 30. As shown in FIG. 4, when the tool 1 is inserted in the access port 21, the tool shaft 10 is flexible enough to bend and deflect to extend through the intake grate 30, as shown in FIG. 3. The tool shaft 10 is resilient enough to return to its original shape after being retracted from the access port 21. The proximal handle 12 is wider than the access port 21.

Although the present invention has been described in considerable detail with reference to certain preferred versions thereof, other versions are possible. Therefore, the spirit and scope of the appended claims should not be limited to the description of the preferred versions contained herein.

1. A method for clearing a blockage from an intake of a jet-powered water vehicle having a cleanout port for accessing the intake, which comprises:
providing a tool with a shaft having a length, the length being at least as long enough to reach a distal point of the intake less a length of a forearm of a user, said shaft having a distal tip on said shaft, said shaft being made of flexible resilient material, said distal tip extending colinearly from said shaft;
inserting said shaft into the cleanout port; and
reaching with said distal tip into the intake of the jet-powered water vehicle.

2. The method according to claim 1, which further comprises moving said distal tip along an intake grate of the intake in order to clear the blockage from the intake grate.

3. The method according to claim 2, wherein said distal tip is narrower than a space between adjacent tines of the intake grate.

4. The method according to claim 3, wherein said shaft is narrower than said distal tip.

5. (canceled)

6. The method according to claim 1, wherein said flexible resilient material is a resin.

7. The method according to claim 6, wherein said flexible resilient material includes crosslinked polyethylene.

8. The method according to claim 7, wherein said shaft is a tube.

9. The method according to claim 2, wherein said tool has a handle connected to a proximal end of said shaft, said handle being wider than the cleanout port, and said length of said shaft being at least as long as a distance from a top of the cleanout port to the distal point of the intake grate.

10. The method according to claim 9, wherein said handle is at least twenty-two centimeters wide.

11. The method according to claim 1, which further comprises removing an access port cap from said cleanout port before inserting said shaft into the cleanout port.

12. The method according to claim 1, wherein the jet-powered water vehicle has a hull, and the cleanout port reaches above the hull.

13. The method according to claim 1, which further comprises standing on a swim platform of the jet-powered water vehicle while inserting said shaft into the cleanout port.

14. The method according to claim 1, wherein said shaft has a length, said length being at least one hundred nine centimeters.

15. A method for clearing a blockage from an intake a jet-powered water vehicle having an access port for accessing the intake from a swim platform of the jet-powered water vehicle, which comprises:
providing a tool with a shaft having a length and a distal tip, the length being at least as long enough to reach at least one of an intake grate, a drive shaft, an impeller, a pump housing, and a jet thrust nozzle, said shaft being made of flexible resilient material, said distal tip extending colinearly from said shaft;
inserting said shaft into the access port; and
moving said distal tip along said at least one of an intake grate, a drive shaft, an impeller, a pump housing, and a jet thrust nozzle to clear the blockage from the intake.

16. A tool for cleaning a blockage from an intake of a jet-powered water vehicle having an access port for accessing the intake, comprising:
a shaft having a distal end, a proximal end, and a length between said distal end and said proximal end, the length being at least as long enough to reach the intake from a top of the access port; and
a handle being connected to said proximal end, said handle being wider than the access port.

17. The tool according to claim 16, wherein said shaft includes a reinforced polyethylene tube.

18. The tool according to claim 16, wherein said shaft and said handle are formed as a unibody.

19. The method according to claim 2, which further comprises deflecting the distal tip against an aft wall of the intake to bend the shaft while pushing the distal tip toward the intake grate.
